(19) United States
(12) Patent Application Publication
(10) Pub. No.: US 2003/0014373 A1
(43) Pub. Date: Jan. 16, 2003

(54) System and method for matching business partners

(76) Inventors: Damir Perge, Saratoga, CA (US); Lonnie J. Eldridge, San Mateo, CA (US)

Correspondence Address: William J. Kolegraff, 3119 Turnberry Way, Jamul, CA, 91935, US

(21) Appl. No.: 09/904,645

(22) Filed: Jul. 13, 2001

(51) Int. Cl. G06F 17/60

(52) U.S. Cl. 705/80

(57) ABSTRACT

The matching system incorporates a method enabling a presenter, such as a company seeking funding, to prepare a profile template. The profile template provides information parameters useful for a searcher, such as a venture capitalist, to make an initial partnering decision. The presenter may indicate a level of privacy for each information parameter in the profile, which is useful in limiting the dissemination of information. In identifying potential matches, the matching system uses all available information parameters, irrespective of any privacy limitation. When a match is confirmed by the matching system, notifications are restricted from transmitting information parameters having a privacy level indicating the presenter did not desire to disseminate that information.

### FIELD

The field of the present invention is electronic data processing systems. More particularly, the present invention relates to an electronic processing system for identifying and matching business partners.

### BACKGROUND

In the world of business, it is often necessary to exert considerable time and energy in pairing service providers with those needing such business services. For example, a company desiring funding may need to conduct a substantial search to find a person or company willing to fund them. Conducting such a search is not only time-consuming, but is often futile as the networking base of most individuals is quite limited. Due to the limited knowledge of any one person, brokers, such as financial brokers, have typically facilitated pairing those needing services with business service providers. These financial brokers are professionals in the field and maintain a larger inventory of service providers. However, even the most knowledgeable financial broker is still limited in the number of contacts they maintain in their networking model.

In the traditional networking model, a broker who had investment clients might learn of investment opportunities and pass the opportunities along to those clients. The scope and breadth of this informal networking system is limited by the number of clients and investment opportunities that a particular broker can competently handle.

Since individual financial brokers are limited, financial brokerage firms have evolved that have larger networking bases and contacts. Unfortunately, the large financial brokerage firms typically extract a substantial fee for their services. Typically, these large financial brokerage firms will even require that a company seeking funding assign a portion of that company's outstanding stock to the brokerage firm upon successful funding. Accordingly, use of the large financial brokerage firms is out of reach for the vast majority of companies seeking services and those providing such services.

Although working with brokers and brokerage firms has limitations, working with these brokers and brokerage firms offers an advantage of allowing the broker or brokerage firm to act as an intermediary. As an intermediary, brokers or brokerage firms can suggest potential matches between those needing services and service providers while maintaining confidentiality of private information. For example, a broker may present the pedigree of the owners of a new company and that company's financial health without disclosing information that would allow the service provider to identify the company. In such a manner, a company desperately seeking funding to avoid bankruptcy would not risk dissemination of such private information. Thus, a broker or brokerage firm may identify potential matches in an anonymous manner, although such identification may be limited or expensive.

As described above, the excessive cost excludes many service providers and those needing services from using the services of large financial brokerage firms, and a typical private broker has only a limited range of matchmaking potential. Therefore, online matching services have been developed. These online services enabled those seeking services to present their information on a web site or bulletin board system, for example. In a similar manner, those offering services may also present their information on the web site or bulletin board system. Parties then perform queries into the stored information to identify potential matches. After reviewing the stored information regarding identified matches, the searcher may then proceed to contact the presenter directly.

The online matching services provide for substantial ease-of-use and offer the ability to maintain a significant database of service providers and those needing services. However, such online matching services fail to provide the necessary anonymity as previously provided by the personal broker. Such discrete intermediaries could match parties without revealing unnecessary information. Automated connection services to date have suffered from the lack of such an intermediary, which causes participants to limit the details about their companies or services. For example, it is unlikely that a venture capitalist will indicate interest in a company unless that company discloses enough information to convince the venture capitalist that the company is operating pursuant a viable business plan. Unfortunately, the company is unlikely to disclose such sensitive and detailed information knowing that the information may be fairly widely disseminated. Thereby, the company fails to disclose enough information to fairly disclose to the venture capitalist its real financial potential. Accordingly, a potentially successful match is missed due to the company's fear of disclosing private information.

In a similar fashion, service providers also may fail to disclose pertinent information. For example, past successes are a strong indicator of future potential. Therefore service providers would benefit from disclosing past pairings where the service provider obtained a desired outcome for its client. However, due to confidentiality concerns, it is unlikely that a service provider will disclose its past successes on an online matching service. Indeed, making such disclosure could even place the service provider at risk of legal action from its past clients.

Another problem with current online matching systems is that the current systems provide only a limited and rather unsophisticated search capability. For example, a typical online matching system provides a simple Boolean query search. Such a search provides an unsatisfactory result when, for example, one of the queried factors has not been completed by the data presenter. In such a manner, the online matching system typically chooses one of two unsatisfactory options in dealing with the missing data. First, traditional system may assume that any missing factor is a positive match and thereby return an inordinately large number of results. Second, the traditional system may assume that the missing factor would not match, and thereby return an artificially small number of results. Either way, the searcher is not receiving and accurate indication all of potential matches.

It has been estimated that there are in excess of two million private investors seeking investment opportunities in early-stage companies. These investors, often referred to as “angel” investors, typically demand a high degree of confidentiality in selecting investment opportunities. These angels are unlikely to participate fully in any on-line system or other matching system that may prematurely disclose their identity. Accordingly, these angel investors are unlikely to use current on-line matching systems, and instead will rely primarily on their informal networks or a trusted intermediary, such as a financial broker.

Therefore, there exists a need for a matching system that provides an efficient and cost-effective pairing of service providers with those needing business services. Importantly, there is a need that such a matching system provide for privacy and anonymity to accommodate the sensitivities of participants. Further, there is a need for a sophisticated matching system that accurately pairs the needs of one party to the proven offerings of another party.

### SUMMARY

It is therefore an object of the present invention to provide an automated system for matching business partners. It is another object of the present invention to enable efficient sharing of information between prospective partners, but to maintain a desirable level of anonymity during the matching process.

To overcome the deficiencies in the prior art, and meet the stated objectives, an automated matching system is disclosed. Briefly, the matching system enables a presenter, such as a company seeking funding, to prepare a profile template. The profile template provides information parameters useful for a searcher, such as a venture capitalist, to make an initial partnering decision. The presenter may also indicate a level of privacy for each information parameter in the profile, which is useful in limiting the dissemination of information. In identifying potential matches, the matching system uses all available information parameters, irrespective of any privacy limitation. When the matching system identifies a potential match, the parties are notified, but the notifications are restricted from transmitting any private information. Accordingly, the matching system emulates an intermediary by using all information to identify a match, but maintaining the confidentiality of private information.

In a particular embodiment of the matching system, the matching system maintains a historical database of past successful matches, and also maintains a file of current presenters and current searchers. Accordingly, the matching system is able to predict which current presenters and searchers are likely to be successfully matched based on the characteristics and parameters of past successful partnerships. More specifically, the matching system selects a target presenter and using historical data identifies a set of searchers that are potential matches for that presenter. Preferably, the target presenter has indicated a desired outcome, such as receiving funding. The matching system finds a set of past presenters in the historical database that are generally similar to the target presenter, and further reduces the set by selecting only those past presenters that successfully achieved the same desired outcome. Since each successful past presenter had a corresponding past searcher, the matching system efficiently generates a set of past searchers that successfully achieved the desired outcome with presenters similar to the target presenter.

If any of the past searchers in the set are also current searchers, they may be notified, without disclosing the presenter's private information, that a match potential has been identified. However, the matching system may also be -configured to expand the number of potential matches. For example, the matching system may use the characteristics of the set of past searchers to find a set of current searchers having similar parameters. Accordingly, the matching system identifies a set of current searchers that have similar parameters to the successful past searchers. By incorporating past success in the selection process, the example searching method is likely to return high quality potential matches.

In another embodiment of the present invention, the matching system provides for a real-time match between presenters and searchers. In one such example, a searcher makes a real-time query into a current database of presenters, with each presenter having an information profile that includes at least one private data parameter. More specifically, the searcher makes a query of information parameters, some of which may be marked as private by the presenter. To facilitate an efficient, yet anonymous exchange of information, the matching system allows a presenter to set a minimum number of the queried parameters that must be private, thereby increasing the anonymity of the transaction. However, to satisfy the searcher that presenters found by the query are acceptable, the searcher is able to set a maximum number of private parameters that are allowed not to match. In this regard, the searcher increases the reliability of the search.

Advantageously, the matching system enables efficient and effective matching of business partners using an automated system. Since the matching system makes matching recommendations based on a broad base of information, the matching system is likely to provide a high quality pairing. Importantly, even though the matching system is making matching decision on the broad base of information, the matching system only provides others information previously approved for dissemination. Accordingly, the matching system acts as an intermediary by facilitating efficient matching while maintaining desirable anonymity.

### BRIEF DESCRIPTION OF THE DRAWINGS

FIG. 1 is a block diagram of a matching system in accordance with the present invention;

FIG. 2 is a sample input form for a matching system in accordance with the present invention;

FIG. 3 is a flowchart of a historical matching system in accordance with the present invention;

FIG. 4 is a flowchart of another historical matching system in accordance with the present invention; and

FIG. 5 is a flowchart of a real-time matching system in accordance with the present invention.

### DETAILED DESCRIPTION

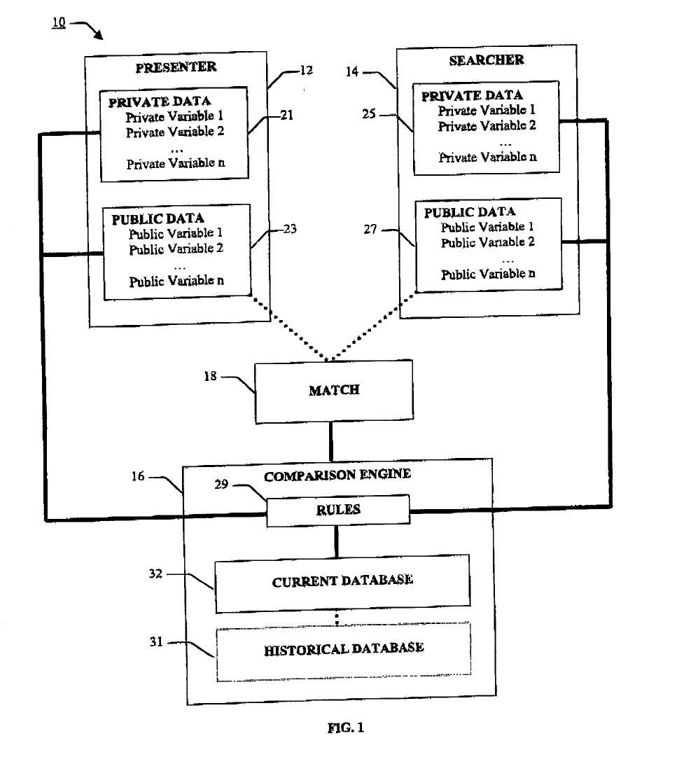

Referring now to FIG. 1, a matching system 10 in accordance with the present intention is shown. Matching system 10 is an online network that matches pre-IPO or other early-stage companies with investors and service providers. In a specific application, the matching system 10 acts as an automated request-for-proposal system. In such a manner, the matching system 10 identifies potential matches between service users and service providers, and facilitates their further detailed communications and proposal evaluation.

Matching system 10 uses a sophisticated comparison engine 16 to facilitate matches to connect companies needing services and service providers so that they can promote, negotiate, share, and transact with one another. By efficiently facilitating such pairings, the matching system 10 creates an online environment in which these entities can achieve better capital and time investments than with traditional off-line or known online networking communities.

Preferably, matching system 10 is arranged as an Internet enabled application. Accordingly, remote parties may conveniently use matching system 10. It will be appreciated that certain aspects of the matching system 10 may be resident on a server, while other aspects are located on a remote client. It will be further appreciated that the relationship between the client and server may be adjusted for application specific needs. For example, some implementations could benefit from increased local processing of data, while other implementations may be more reliant on the server's processing power. Also other implementations of the matching circuit 10 are also contemplated, such as bulletin board systems or other such online systems.

In a particular application of the matching system, clients use a mobile wireless device to communicate with the server. For example, personal data assistants are available with integrated data modem capability. In this regard, the personal data assistant may be enabled to interactively communicate with a server implementing a matching method. In this configuration, the server preferably manages and performs most significant processing and storage functions, as storage capability and processing power is more limited in the wireless device. It will be appreciated that other mobile wireless devices may be used to interact with the matching system.

A key feature of matching system 10 is the capability to effectively use all available information while maintaining desirable anonymity. By maintaining the privacy of confidential information, parties are encouraged and enabled to make full and honest disclosures, thereby facilitating effective and efficient matching. Generally, the matching system 10 identifies potential matches by using the full amount of information available for presenters and searchers. However, when a potential match is identified, the matching system 10 does not disseminate information that any party identifies as private. Accordingly, the matching system 10 acts as a sophisticated intermediary that is able to make intelligent matching choices, but still maintain desirable confidentiality. Further, even though confidentiality may be maintained, each party has a high degree of confidence in the results produced by the matching system 10.

For convenience in discussing the matching system 10, it is convenient to consider the party entering information into the system to be a “presenter”, and the party interrogating the system to be a “searcher”. Of course, during a transaction any party may alternatively take on the characteristics of the presenter and the searcher. For example, both the presenter and the searcher may enter relevant information into the matching circuit. In one example of the matching circuit 10, the presenter enters data into the system using a presenter profile template 12, while the searcher enters data into system using a searcher profile template 14. The presenter profile template 12 includes private presenter data 21 and public presenter data 23. In a similar manner, searcher profile template 14 includes private searcher data 25 and public searcher data 27. As the profile templates for the presenter and the searcher are similar, only the presenter profile template 12 will be discussed in detail.

Generally, the presenter supplies the presenter profile template 12 with enough information to enable the matching system to effectively locate a likely match. As privacy of the information is assured, the presenter is enabled to make a full and honest disclosure of information. In entering the data, the presenter enters specific information into variables.

A preferred profile template comprises several variables. For example, a typical template may include 20 or more variables. The presenter selects which of these variables are appropriate to answer, and supplies the necessary information to complete the variable. Each variable may then be assigned a particular privacy level. In a preferred embodiment, each variable may be assigned either a “private” privacy level or a “public” privacy level. For example, selected variables in presenter profile template 12 have been designated as private. Accordingly, this data is identified as private presenter data 21. Other data variables in the presenter profile template 12 have been designated as public. The public data variables are shown as public presenter data 23. It will be appreciated that the matching system 10 may incorporate more than 2 levels of privacy to facilitate a more sophisticated control of information flow.

The presenter completes the presenter profile template 12 by entering specific information into variables. For consistency, the variables are typically predefined to facilitate effective matching. For example, one predefined variable may ask that a presenter define the primary industry for the company. When completing this variable, the presenter may be asked to make a selection from a predefined list. The list could integrate several choices, such as biotech, electronics, Internet, software, medical, and other industry choices. Preferably, the list is configured as a selection box for an online system. It will be appreciated that other input methods may be used, such as check boxes or radio buttons.

The matching system 10 has a comparison engine 16 for identifying potential matches. More specifically, the comparison engine 16 maintains a current database 32 of active current presenters and active current searchers. Each of the current participants has previously completed a profile template, such as presenter profile template 12. The comparison engine 16 also includes a set of sophisticated rules 29. Typically, the rules 29 will be implemented as software algorithms. Depending on the particular matching situation, the comparison engine 16 may apply different rules 29. Specific rules will be more fully addressed below.

In one particular example of matching circuit 10, the comparison engine 16 also includes an optional historical database 31. The historical database 31 includes records of past successful matches. A match is considered successful when a presenter and a searcher reached the outcome desired by the presenter. Further, the historical database may additionally track previous pairings that did not result in a successful match.

The rules 29 of comparison engine 16 use all available information on presenters and searchers to identify potential matches. For example, rules 29 use both the private data 21 and public data 23 in presenter profile 12 when attempting to identify a potential match for that presenter. In a similar manner, rules 29 use all available data from a searcher, such as private data 25 and public data 27 in searcher profile template 14. Additionally the rules 29 have access to full private and public data in the current database 32 and the historical database 31, if present.

Once the comparison engine 16 identifies potential match, the match is identified by match presentation 18. In a preferred embodiment, match presentation 18 is accomplished via an e-mail notification. More specifically, a presenter may be notified that a particular searcher is a potential match, and the searcher may likewise be notified that the presenter appears to be a match. The system may be configured so that only one party, such as the searcher, receives the notification.

In the notifications, the matching system 10 does not disclose any private data, such as private presenter data 21 or private searcher data 25. Instead, matching system 10 only discloses information identified as being public. It will be appreciated that more sophisticated control of information may be accomplished by incorporating more than 2 levels of privacy. It will also be appreciated that other methods of notification may be used.

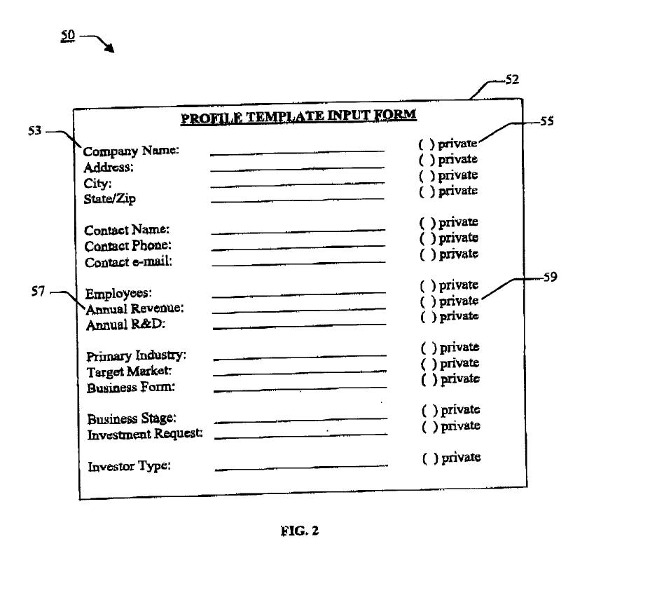

Referring now to FIG. 2, an example profile template input form 50 is shown. In a preferred embodiment, form 52 is similar for both the presenter and the searcher. In use, the presenter uses information variables on form 52 to present information regarding themselves, while the searcher would use similar variables on a similar form to describe qualities and features they are searching for. Accordingly, similar input forms may be used whether searching or presenting on the matching system.

The input form 52 includes several variables, such as company name 53 and annual revenue 57. On form 52, each variable has a label and an area for inserting information. It will be appreciated that any number of variables may be used, however, enough variables should be presented and collected to enable efficient and accurate matching. Generally, the more variables presented and completed, the better the matching accuracy and efficiency.

Form 50 invites a person completing the form to provide specific information regarding the entity they represent. Some of the input variables, such as company name 53, may require a free form input format. Other input variables, such as annual revenue 57, lend themselves to selectable items. For example, the input area for annual revenue 57 may include a pull down box where the person completing the form selects one of several revenue ranges. It will be appreciated that other selectable input methods may be used. Alternatively, data variables such as annual revenue 57 may also be arranged as free form input, but then the rules used by the comparison engine must be constructed to interpret such free form input.

Form 52 also permits the person completing the form to indicate a privacy level for each data variable. For example, the person completing the form may indicate that the company name 53 shall remain private by selecting private box 55. In a similar manner, annual revenue 57 could be made private by selecting private box 59. In a particular illustration, the person filling out form 52 may identify annual revenue 57 as private. Even though identified as private, the rules of the comparison engine will still use annual revenue 57 in locating potential matches. However, once a potential match is identified, the potential match will receive a notification that does not disclose annual revenue 57. Accordingly, the matching system fully utilizes all information it receives in making efficient matches, but protects from dissemination any information that the discloser regards as private.

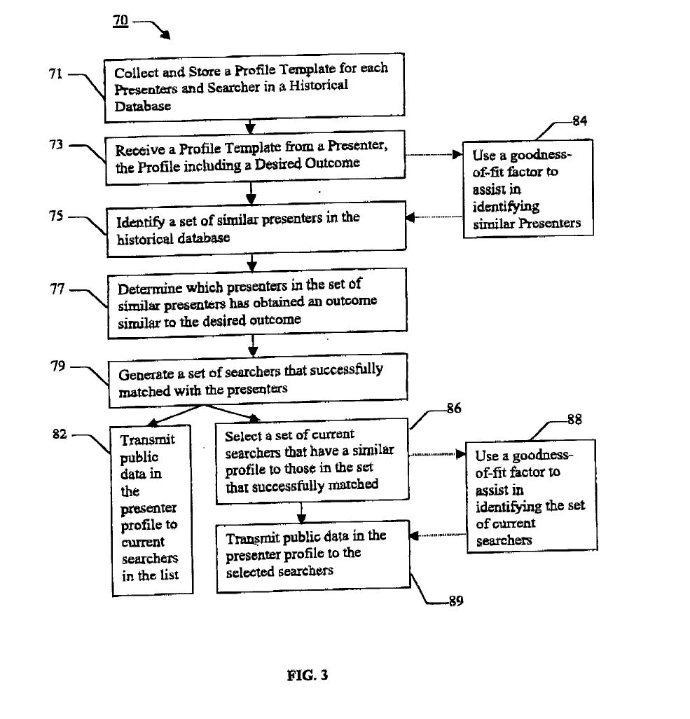

Referring now to FIG. 3, a specific method of matching 70 is disclosed. In particular, matching method 70 uses a historical database that includes successful matching pairs to more effectively identify potential matches. It will be appreciated that the historical database may contain other information, such as information regarding unsuccessful previous pairings. Additionally, it will be appreciated that the historical database may contain information received from other public or private sources. In this regard, a newly activated matching system may still incorporate a degree of historical database. Of course, as time progresses, the information contained in the historical database will increase and the system is likely to yield more effective potential matches.

Block 71 shows that matching method 70 collects and stores profile template information for past presenters and past searchers in the historical database. As described above, such profile information may include information derived from other private or public sources. The information stored regarding the presenters and the searchers will include an indication of whether particular matched pairs were able to reach a desired outcome, such as a funding event. It will be appreciated that other desired outcomes could be tracked, such as the successful incorporation of a new company by a lawyer. Although system 70 contemplates using historical success data, it will be appreciated that information indicating an unsuccessful match may also be useful.

In block 73, a current presenter completes a profile template, which includes an indication of the outcome desired by that presenter. It will be appreciated that the profile template may include any number of data variables, and the data variables may be assigned a privacy level with at least some of the data variables identified to be private.

In block 73, the profile template of the current presenter is used to identify a set of similar past presenters. More specifically, the method 70 compares the data variables, including private variables, in the current presenter's profile template to the profile templates of past presenters. The method selects a set of those past presenters having similar data parameters. It will be appreciated that block 75 could be implemented in alternative ways. For example, block 75 could require exact matches between all data variables before selecting a past presenter. Alternatively, a goodness of fit factor could be used, as shown in block 84, to expand the number of past presenters selected as being similar. For example, block 84 could require that the current presenter and a past presenter have a minimum number of matching data parameters before the past presenter is selected. In such a manner, a past presenter would be identified as similar even though all data parameters may not match exactly. It will be appreciated that other methods may be used to expand the set of similar past presenters returned by the system in block 75.

With the set of similar past presenters defined, block 77 uses the historical database to determine which of the presenters in the set obtained the same outcome desired by the current presenter. For example, if the current presenter is attempting to obtain funding, then block 77 would select only those past presenters that successfully obtained funding for their respective searchers. The past presenters that did not obtain the desired result are excluded from the set. It will be appreciated that the determination of successful past presenters in blocks 75 and 77 may be accomplished using a different sequence. For example, the method could first select past presenters that reached the desired outcome, and then select only those past presenters that are similar to the current presenter. It will be appreciated that other procedures may be used to select a set of similar successful past presenters.

The historical database contains information regarding successful matches, including the identities of the presenter and the searcher. Accordingly, in block 79 the method 70 is able to generate a set of past searchers that correspond to the set of past presenters generated in block 77. This set of past searchers contains those past searchers that successfully reached the desired outcome with presenters similar to the current presenter.

It is possible that one or more of the selected past searchers are still active current searchers in the system. If so, in block 82 active searchers may be extracted from the set of past searchers and these searchers notified about the current presenter. In accordance with the method 70, none of the private information of the current presenter is disclosed to the searchers.

With an online system, it is likely that current searchers will continually be added or deleted from the system. Accordingly, the set of searchers generated in block 79 will likely contain past searchers that are no longer active in the system, and will not indicate other newer searchers that may be interested in knowing about the current presenter. Therefore, in block 86 the method uses the set of past searchers generated in block 79 to generate a set of current similar searchers.

More particularly, searchers in the set of current searchers are selected to have a similar profile as to those searchers in the set of past searchers. As with the procedure described above, similar searchers are selected based on matches of data variables, including private variables, in their profile template. A goodness of fit factor, as shown in block 88, may be used to expand the set of similar searchers. For example, the goodness of fit factor may be set to select searchers where only a set number of factors match.

In block 89, public information regarding the current presenter is transmitted to the searchers in the set of similar searchers. As above, the searchers do not receive any information the presenter indicated as private, although the private information was used in the matching process.

In a particular example of method 70, the goodness of fit factor of block 84 and the goodness of fit factor of block 88 may be adjustable. In this regard a user of method 70 may adjust the factors in order to obtain the desired quantity and quality of results. For example, a particular search may be more successful by stringently selecting the set of similar presenters while more loosely selecting the set of current searchers. It will be appreciated that the goodness of fit factors may be made adjustable in alternative ways, such as by allowing a searcher to adjust slider bars or selecting a minimum number of factors that must match exactly.

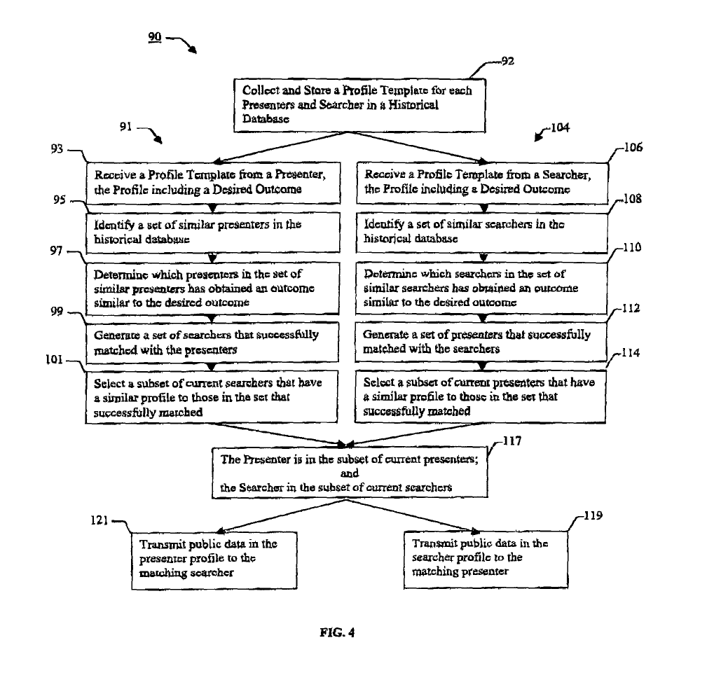

Referring now to FIG. 4 another method of matching 90 is disclosed. Matching method 90 provides a process that generates a limited number of high-quality potential matches. Accordingly, matches generated by method 90 may have a high probability of generating a desired outcome. Portions of method 90 are similar to method 70, previously described, so will not be detailed. For example, in block 92 profiles are stored in a historical database similar to the manner already described. Further, blocks 93, 95, 97, 99, and 101 define a set selection process 91 that generates a set of current searchers similar to the process already defined in method 70. In particular, set selection process 91 operates on a profile template from a current presenter. However, method 90 uses the generated set of current searchers differently than method 70.

Method 90 generally applies the set selection process 91 to other current profile templates. For example, set selection process 104 is similar to set selection process 91, except that set selection process 104 is applied to a current searcher profile. More particularly, blocks 106, 108, 110, 112, and 114 of set selection process 104, are similar to blocks 93, 95, 97, 99, and 101 of set selection process 91, respectively. Although method 90 shows the set selection process 91 and 104 operating on only two profile templates, it is contemplated that method 90 may perform a similar set selection process on several profile templates. For example, method 90 may even perform a set selection process for every current profile template. It will be appreciated that method 90 may be automatically performed or may be done in response to an instruction, such as a user command.

The set selection process, such as set selection process 91 or 104, generates a potential match list for each profile template. More specifically, the potential match list from process 91 identifies potential current searchers for the presenter, while the potential match list from process 104 identifies potential current presenters for the searcher. If the searcher appears in the presenter's match list, and the presenter appears in the searcher's match list, then the method has a high degree of confidence that the presenter and the searcher are a good match. Therefore, block 117 attempts to locate the presenter in the subset of current presenters generated in block 114, and also attempts to locate the searcher in the subset of current searchers generated in block 101. If both conditions are met, then method 90 proceeds to notify the presenter in block 121 and the searcher in block 119 that a potential match has been identified. In accordance with method 90, no private information is disseminated, although the private information was used in making the match.

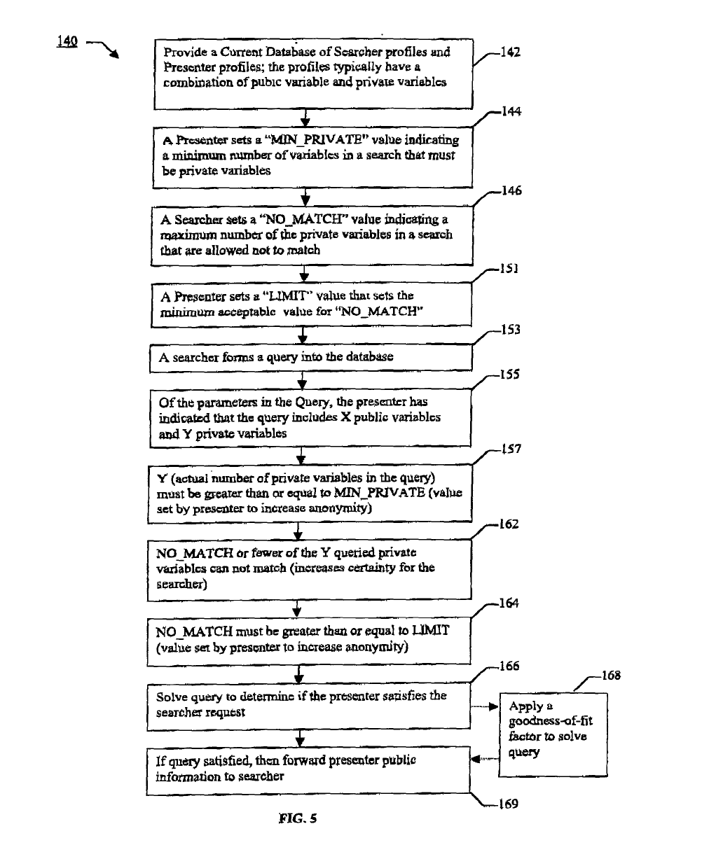

Referring now to FIG. 5, another method of matching 140 is disclosed. Matching method 140 is preferably a real-time matching system. In this regard, a searcher generates a query into a database of current presenters, with method 140 returning a list of potential matching presenters. As briefly described earlier, a single party may at times take on the characteristics of the presenter and at a different times take on the characteristics of the searcher. For example, a company seeking funding may complete a template as a presenter and have a template stored in the database. At another time, that same company may perform real-time searches into a database of service providers. Accordingly, the terms presenter and searcher are used flexibly.

Although not required, the real-time system may also benefit from a historical database. Such a historical database could provide the search engine with additional information to form more efficient and effective matching lists. However, for purposes of describing method 140, the historical database will not be described.

A real-time matching method, such as method 140, generally operates by having a searcher make a query into a database. More specifically, the searcher selects particular variables to query, and selects a value or a range of values acceptable for each variable. Matches are identified when there is a high degree of similarity between the variables in the query and the respective variables in a profile template. Depending upon the specific application, differing degrees of similarity may be required. For example, a query may be made that requires only a minimum number of variables to match. In this regard, even if several variables do not match, the profile template may be identified as a potential match. In a particular embodiment of method 140, a goodness of fit variable may be set for adjusting the requisite similarity to identify a match.

In a real-time matching system, such as matching system 140, the needs of a searcher may be in tension with the needs of a presenter. For example, the presenter probably desires to retain a high level of anonymity, which suggests that the search be accomplished with at least some degree of uncertainty. In contrast, the searcher probably desires that the match have as high a degree of certainty as possible. Accordingly, method 140 provides a process that strikes a balance between the uncertainty desired by the presenter and the certainty desired by the searcher.

In block 142, a current database of profile templates is provided. The database typically includes information profiles stored by other searchers and presenters, and includes a combination of public and private variables. It will be appreciated that although method 140 uses two levels of privacy, additional levels may be used to more finely controlled dissemination of data parameters.

As shown in block 144, the presenter is able to influence the level of uncertainty for a search. More specifically, each presenter sets a variable, identified as “MIN_PRIVATE”, that is stored with their profile template. This value sets the minimum number of variables in a query that the presenter must have identified as private. For example, assume that a particular presenter has set MIN_PRIVATE to a value of 2. Further, assume that a searcher prepares a query into the database using 5 variables, and that the particular presenter has identified only 1 of the 5 queried variables as private. In this example, even if all 5 variables match, method 140 will not identify this presenter as a potential match. In this regard, the presenter has made a decision that they want to retain anonymity by increasing the level of uncertainty of the search. Of course, the presenter may be able to increase the number of matches by reducing the value the set for MIN_PRIVATE. For example, in the example described above, setting MIN_PRIVATE to a value of 1 may have allowed the presenter to be matched with the searcher.

However, as described earlier, a searcher has an interest in increasing the level of certainty in a search. Accordingly, in block 146, the searcher is able to set the value for a variable identified as “NO_MATCH”. With this variable, the searcher sets the maximum number of private variables in a search that are allowed not to match. Thereby, even if a substantial number of the variables queried by the searcher are held private by the presenter, the searcher has control over the maximum number of private variables that do not match. By reducing the value of NO_MATCH, the searcher is able to increase the certainty of the search. Of course, if the searcher reduces NO_MATCH too low, then the searcher may exclude desirable potential matches.

In block 151 the presenter also sets a “LIMIT” variable. The value of LIMIT permits the presenter to set a minimum value for the NO_MATCH value, which is set by the searcher. In this manner the presenter can again influence the level of uncertainty in the search. More specifically, the value of NO_MATCH must be greater than or equal to LIMIT for the presenter's profile to be considered by the matching method. For example, the presenter may set the value of LIMIT high enough so that the searcher cannot confidently predict which variables did not match.

The method 140 contemplates that MIN_PRIVATE and LIMIT are set and adjustable by the presenter, and the NO_MATCH is set and adjustable by the searcher. It will be appreciated that not all these variables need to be present on each implementation of a real-time matching system, and that additional such limiting variables may be added. Further, it is understood that one or more of these variables may be set by the matching method, either statically or in response to a rule.

A searcher forms a query into the database in block 153. In making the query, the searcher does not know which of the queried variables any particular presenter has made private. As described earlier, the matching method has access to all information, whether or not private. Therefore, as shown in block 155, the matching method can identify which of the queried variables are public or private for each presenter. For convenience of discussion, the number of private variables will be assumed to have a value of Y. For each presenter, as shown in block 157, Y must be greater than or equal to the value of MIN_PRIVATE for that presenter to be considered further. Put another way, if Y is less than MIN_PRIVATE for a particular presenter, then the presenter is excluded from further consideration in this query. Since Y and MIN_PRIVATE vary between presenters, a searcher may get very different results using slight variations in a query.

To assure a minimum level of certainty, in block 162 NO_MATCH is compared to the number of private variables that do not match. In this regard, NO_MATCH sets the maximum number of private variables that cannot match. For example, if NO_MATCH is set to the value 2, then no more than 2 private variables can not match. If 3 private variables do not match, then the query exceeds the level of certainty requested by the searcher, and the particular presenter profile is removed from further consideration in this query.

It may be possible, however, that the searcher sets NO_MATCH to a very low number, for example, 1. Thereby, no more than 1 private variable is allowed not to match. Such a level of certainty, although desirable for the searcher, may not provide the necessary level of anonymity for the presenter. Therefore in block 164 the value of NO_MATCH must be greater than or equal to the value of LIMIT. For example, assume the presenter sets the value of LIMIT at 2, then the matching method removes the presenter's profile from further consideration when NO_MATCH is set to only 0 or 1. It will be appreciated that other methods may be used to adjust the uncertainty in the matching process.

Provided that the searcher and presenter have agreed on a proper level of certainty and anonymity in blocks 157, 162, and 164, then the method 140 proceeds to block 166. In block 166 the variables in the searcher's query are compared to corresponding variables in the presenters' profile templates. If the comparison identifies a sufficient degree of similarity between the query and presenters' profiles, then the searcher is notified of the matches. Of course, block 169 indicates that the searcher only receives information that has not been identified as private by each of the presenters. Although method 140 may set a specific degree of similarity required to satisfy the query, block 168 may be used to provide a goodness of fit factor for adjusting the requisite similarity. Accordingly, the degree of similarity could be adjusted from needing an exact match to expanding identified matches to include those where several factors do not match. It will be appreciated that different goodness of the factors may be used in varying applications.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A process operating on a computer system, the process for matching business partners, comprising:
receiving current presenter information that includes a plurality of current presenter parameters;
identifying at least one of the current presenter parameters as a private parameter;
receiving current searcher information that includes a plurality of current searcher parameters;
comparing current presenter parameters, including the private parameter, to corresponding current searcher parameters;
determining if the current presenter and the current searcher are a match; and
transmitting current presenter parameters, excluding any private parameters, to the current searcher.

2. The process according to claim 1, further including the step of maintaining a current database of current searchers and current presenters.

3. The process according to claim 1, further including the step of maintaining a historical database of past successful matches between past searchers and past presenters.

4. The process according to claim 3, further including the steps of:
interpreting one of the current presenter parameters to indicate a desired outcome;
extracting from the historical database a set of similar past presenters that have parameters similar to those of the current presenter; and
defining a corresponding set of similar past searchers, each searcher in the set of similar past searchers having reached the desired outcome with a corresponding past presenter in the set of similar past presenters.

5. The process according to claim 4, wherein a goodness-of-fit factor is used in selecting the set of similar past presenters, the goodness-of-fit factor indicative of a minimum number of parameters that must match.

6. The process according to claim 4 further including the step of reviewing the set of similar past searchers to identify a current searcher, and arranging for the selected current searcher to receive the transmitted current presenter parameters.

7. The process according to claim 4 further including the step of selecting matching current searchers from a database of current searchers, the matching current searchers having parameters similar to those in the set of similar past searchers, and selected to receive the transmitted current presenter parameters.

8. The process according to claim 7, wherein a goodness-of-fit factor is used in selecting the current searcher, the goodness-of-fit factor indicative of the minimum number of parameters that must match.

9. The process according to claim 8, wherein a goodness-of-fit factor is used in selecting the set of similar past presenters, the goodness-of-fit factor indicative of a minimum number of parameters that must match.

10. The process according to claim 3, further including the steps of:
interpreting one of the current presenter parameters to indicate a desired outcome;
extracting from the historical database a set of similar past presenters that have parameters similar to those of the current presenter;
defining a corresponding set of similar past searchers, each searcher in the set of similar past searchers having reached the desired outcome with a corresponding past presenter in the set of similar past presenters;
selecting matching current searchers from a database of current searchers, the matching current searchers having parameters similar to those in the set of similar past searchers;
extracting from the historical database a set of similar past searchers that have parameters similar to those of the current searcher;
defining a corresponding set of similar past presenters, each presenter in the set of similar past presenters having reached the desired outcome with a corresponding past searcher in the set of similar past searchers;
selecting matching current presenters from a database of current presenters, the matching current presenters having parameters similar to those in the set of similar past presenters;
finding the current presenter in the selected matching current presenters; and
finding the current searcher in the selected current matching searchers.

11. The process according to claim 1, wherein the determining step further includes using a goodness-of-fit factor indicative of the minimum number of parameters that must match.

12. The process according to claim 1 wherein the identifying step includes identifying presenter parameters using two privacy levels, public or private.

13. The process according to claim 1 wherein the identifying step includes identifying presenter parameters using more than two levels of privacy.

14. The process according to claim 1, further including the step of receiving from the presenter a value setting the minimum number of private parameters that must be used in the determining step.

15. The process according to claim 1, further including receiving from the searcher a value setting the maximum number of private variables that are allowed not to match in the determining step.

16. The process according to claim 15, further including receiving from the presenter a value setting an acceptable limit on the value the searcher sets as the maximum number of private variables that are allowed not to match in the determining step.

17. The process according to claim 1, further including the step of providing the computer systems as a server portion and a client portion.

18. The process according to claim 17, wherein the client portion is provided as a mobile wireless device.

19. A method for automatically and confidentially matching an investor with an early-stage company, the method operating on a processor, comprising:
receiving investor information from the investor, the investor information including private investor data and sharable investor data;
receiving company information from the early-stage company, the company information including private company data and sharable company data;
comparing the investor information to the company information, including private and sharable data;
identifying a match responsive to the comparison; and
transmitting only sharable investor data to the company, and only sharable company data to the investor.

20. A method of using business information in an on-line environment while maintaining confidentiality, comprising:
accessing a template input form, the form having a plurality of input parameters;
providing data for at least some of the parameters, the provided data parameters forming the business information;
setting a security level for the provided data parameters, at least some of the provided data parameters set with a private security level;
authorizing an electronic intermediary to use all of the business information in a search for a business partner; and
restricting the electronic intermediary from disclosing to the business partner any of the private data parameters.

21. The method according to claim 20 wherein the step of setting the security level includes accepting a default security level.
